(19) United States
(12) Patent Application Publication
(10) Pub. No.: US 2014/0000973 A1
(43) Pub. Date: Jan. 2, 2014

(54) Energy Storage Integrated as Machine Counterweight

(71) Applicants: Timothy M. O'Donnell, Germantown Hills, IL (US); Evan E. Jacobson, Edwards, IL (US)

(72) Inventors: Timothy M. O'Donnell, Germantown Hills, IL (US); Evan E. Jacobson, Edwards, IL (US)

(73) Assignee: CATERPILLAR INC., Peoria, IL (US)

(21) Appl. No.: 13/534,797

(22) Filed: Jun. 27, 2012

(51) Int. Cl. B60K 6/00; B60K 6/28; B60K 6/12; B60K 6/08; B60K 6/10

(52) U.S. Cl. 180/165; 180/9.42; 180/65.21

(57) ABSTRACT

A machine includes a frame, at least one implement, and a linkage assembly movably coupled to the implement and to the frame. The machine also has an energy recovery system that includes an energy storage system. The energy storage system includes at least one of a hydraulic accumulator, a battery, a flywheel, an ultra-capacitor, a fuel cell, and an auxiliary power unit. At least a portion of the energy storage system is disposed as counterweight to the implement.

### TECHNICAL FIELD

This patent disclosure relates generally to machines including hybrid arrangements for energy recovery, and, more particularly to energy storage components of a hybrid arrangement for a machine.

### BACKGROUND

In order to make machines more efficient and to minimize fuel consumption, energy recovery systems in the form of hybrid powertrain systems are becoming more common. Hybrid powertrain systems may recover or recycle energy that would otherwise be lost during operation, and store the potential energy for later use. The energy storage systems for such hybrid powertrain systems, however, may add significant weight to the machine and require a relatively large amount of space within the machine. Moreover, the inclusion of bulky energy systems may result in significant alterations of the machine's center of gravity. As a result, the utilization of such hybrid powertrain systems in machines often presents packaging challenges when attempting to incorporate them into machine designs.

Hybrid powertrain systems may be particularly attractive for use in off-highway machines, which often include hydraulic systems for either or both of the movement of attached implements, or motivation of the machine. The machines often include energy recovery systems to recover or recycle the energy associated, for example, with releasing the implement from the elevated position, or arresting movement of machine. The incorporation of the energy storage systems for such hybrid powertrain systems into off-highway machines may be particularly challenging inasmuch as weight distribution may affect not only operation, but also wear of various components of the machine. In order to meet this challenge, manufacturers often seek to place components of the energy storage systems at or near the center of gravity of the machine in order to minimize the impact on weight distribution. Energy storage systems located at or near the center of gravity of the machine, however, may occupy what is generally considered valuable space under the hood of the machine, potentially undesirably increasing the size of at least portions of the machine.

### SUMMARY

The disclosure describes, in one aspect, a machine having a frame, at least one implement, and a linkage assembly movably coupled to the implement and to the frame. The machine also includes an energy recovery system that includes an energy storage system, The energy storage system includes at least one of a hydraulic accumulator, a battery, a flywheel, an ultra-capacitor, a fuel cell, and an auxiliary power unit. At least a portion of the energy storage system is disposed as counterweight to the implement.

The disclosure describes, in another aspect, a moveable machine having a frame supported on a plurality of motivators, and at least one implement movably coupled to the frame by a linkage assembly. The machine also includes an energy recovery system adapted to recover and store potential energy. The energy recovery system includes an energy storage system having at least one of a hydraulic accumulator, a battery, a flywheel, an ultra-capacitor, a fuel cell, and an auxiliary power unit. At least a portion of the energy storage system is disposed as counterweight to the implement.

The disclosure describes, in yet another aspect, a machine having a frame having at least one implement coupled by way of a linkage assembly substantially at a first end of the frame. The machine also includes an energy recovery system having an energy storage system. The energy storage system has a center or gravity and includes at least one of a hydraulic accumulator, a battery, a flywheel, an ultra-capacitor, a fuel cell, and an auxiliary power unit. The energy storage system is disposed along the frame to have its center of gravity other than coincident with a center of gravity of the machine, and at least a portion of the energy storage system disposed substantially along a second end of the frame as counterweight to the implement.

### BRIEF DESCRIPTION OF THE DRAWING(S)

FIG. 1 is a side elevational, schematic view of machine according to aspects of the disclosure; the view is partially broken away.

FIG. 2 is a side elevational, schematic view of an alternate machine according to aspects of the disclosure.

### DETAILED DESCRIPTION

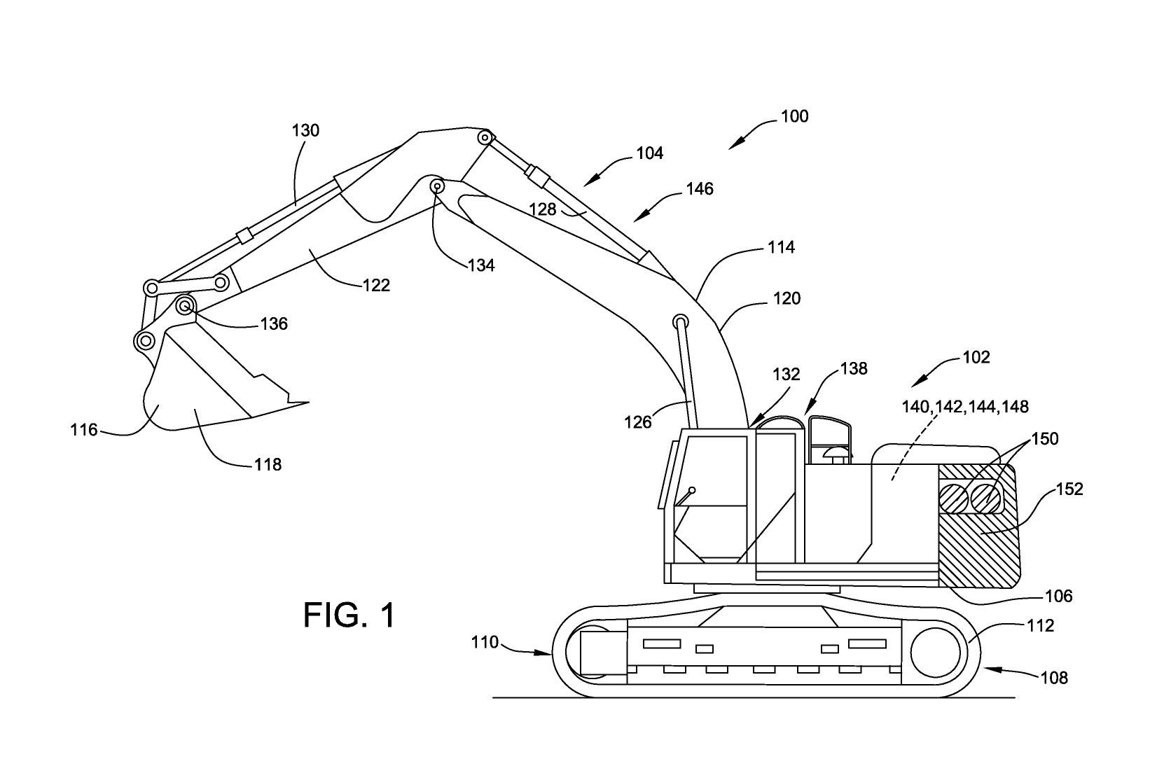

This disclosure relates to a counterweight arrangement for a machine 100, such as an excavator 102 illustrated in FIG. 1, that includes an attachment 104. The illustrated excavator 102 includes a frame 106 that is swingably supported on an undercarriage 108 that includes a plurality of motivators 110. In the illustrated embodiment, the motivators 110 include a pair of rotatably mounted tracks 112 along either side of the undercarriage 108. Alternate embodiments may include, for example, wheels (not illustrated).

In the illustrated embodiment, the attachment 104 includes a linkage 114 which couples an implement 116, here, a bucket 118, to the frame 106. In the arrangement of the illustrated excavator 102, the linkage 114 includes a boom 120 that is pivotably supported on the frame 106, and a stick 122 pivotably coupled to the boom 120, the implement 116 being pivotably coupled to the stick 122. While the implement 116 is illustrated as a bucket 118, the implement 116 may alternatively be, for example, a compactor, a grapple, a multi-processor, thumbs, a rake, a ripper, or shears.

Movement of the boom 120, stick 122, and implement 116 is controlled by a number of actuators 126, 128, 130. The boom 120 is pivotably coupled to frame 106 at one end 132. To control movement of the boom 120 relative to the frame 106, the pair of actuators 126 is provided, only one being visible in the FIG. 1. The actuators 126 are disposed on either side of the boom 120, coupled at one end to the frame 106, and at the other end to the boom 120. The stick 122 is pivotably coupled to the boom 120 at a pivot connection 134; movement of the stick 122 relative to the boom 120 is controlled by the actuator 128. The implement 116 is pivotably coupled to the stick 122 at pivot connection 136; movement of the implement 116 relative to the stick 122 is controlled by actuator 130.

Other structures and components supported on the frame 106 may include, for example, a cab 138 for carrying an operator (not shown), an engine 140, components of a hydraulic system 142, and components of an energy recovery system 144. The engine 140 may be of any appropriate type. For example, the engine 140 may be an internal combustion engine or any type power source known to one skilled in the art now or in the future.

The hydraulic system 142 may control operations of the machine 100, such as, for example, the swinging of the frame 106 relative to the undercarriage 108, or movement of the motivators 110 to propel the machine 100, and operation of the actuators 126, 128, 130, and, therefore, the movement of the boom 120, stick, 122, implement 116, and any supplemental load carried by or contained within implement 116. For the purposes of this disclosure, the term “load” 146 will be used to describe the implement 116, any supplemental load carried by or contained within the implement 116, and any linkage 114 extending from the frame 106 and coupling the implement to the frame 106. In the illustrated embodiment, for example, the load 146 would include the boom 120, stick 122, implement 116, and actuators 126, 128, 130, as well as any supplemental load, such as dirt, carried within the implement 116. In another application, such as when actuators directly move an implement, for example, the load may be the actuators, the implement and any supplemental load.

The energy recovery system 144 may include a hybrid powertrain system 148 that is adapted to recover, store, and reuse potential energy that would otherwise be lost in the operation of the machine 100. For example, during operation of the machine 100, the implement 116 may be raised to an elevated position. As the implement 116 may be relatively heavy, the implement 116 may gain potential energy when raised to the elevated position. The energy recovery system 144 may recover or recycle the energy associated with releasing the implement 116 from the elevated position. By way of further example, in machine 100 such as the excavator 102 illustrated in FIG. 1, when the frame 106 is rotated relative to the undercarriage 108, the frame 106 may gain potential energy. When rotation is no longer desired, the energy recovery system 144 may likewise recover energy associated with arresting the swing of the frame 106 relative to the undercarriage 108. The hybrid powertrain system 148 recovers and stores this energy in an energy storage system 150 for later use. The hybrid powertrain system 148 then recycles this stored energy to power operations of the machine 100. The operation of the energy recovery system 144 including the hybrid power train system 148 is known and will be understood by those of skill in the art.

The energy storage system 150 may include components that store energy in electrical, chemical, hydraulic, or mechanical form. By way of example only, the energy storage system 150 may include one or more components such as a flywheel, a battery, an ultracapacitor, a fuel cell, an auxiliary power unit, and one or more accumulators.

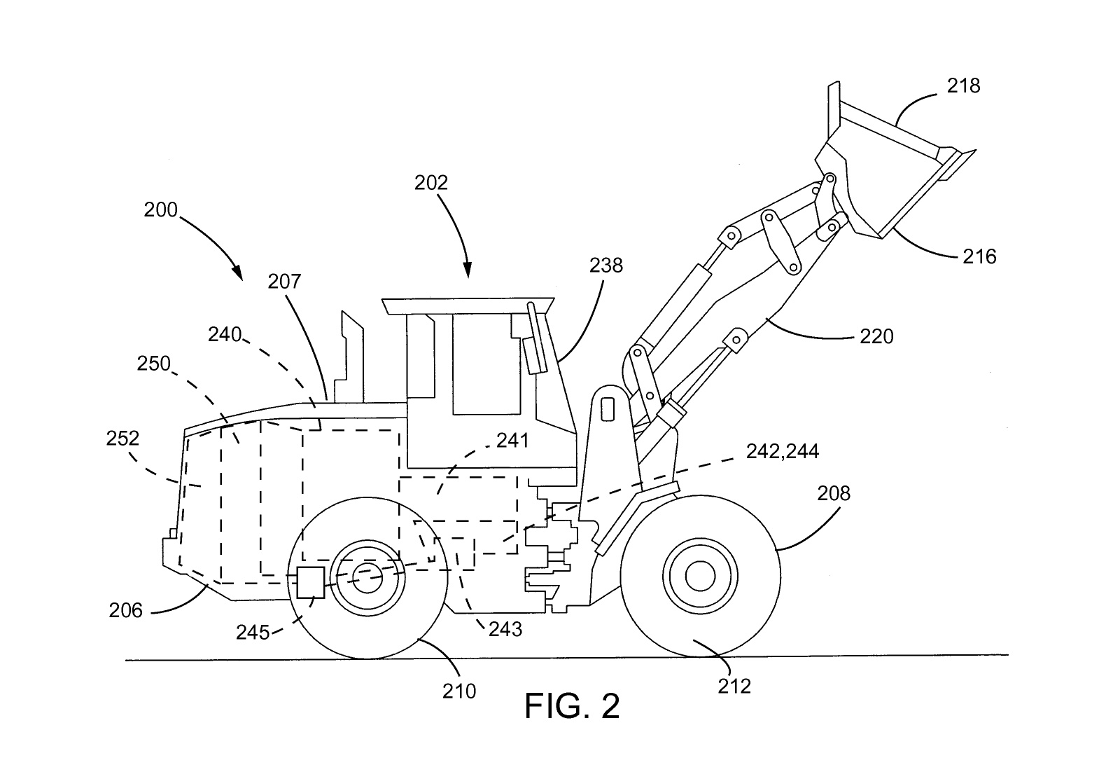

According to an aspect of this disclosure, at least a portion of the components of the energy storage system 150 are disposed as a counterweight to the load 146, including the implement 116 and linkage 114. In the excavator 102 illustrated in FIG. 1, it will be understood that the center of gravity of the frame 106 is typically disposed coincident with the axis of rotation of the frame 106 relative to the undercarriage 108. As illustrated schematically in FIGS. 1 and 2, at least a portion of the energy storage system 150 is disposed to act as a counterweight to the load 146 of the implement 116 and linkage 114. In this embodiment, at least a portion of the energy storage system 150 is disposed relative to the frame 106 generally opposite the attachment of the linkage 114 and implement 116. In other words, the center of gravity of the energy storage system 150 is disposed other than coincident with the center of gravity of the machine 100, and, more particularly, the frame 106 and everything supported on the frame 106 in the illustrated excavator 102. As a result, the counterweight of the energy storage system 150 creates a moment opposite that created by the load 146 to negate at least a portion of the moment applied to the frame 106 from the linkage 114 and implement 116. It will be noted that the machine 100 may include additional counterweight 152, as illustrated in FIG. 1.

Turning now to FIG. 2, an alternate exemplary machine 200 in the form of a wheel loader 202 is provided. The wheel loader 202 includes an articulated frame 206 supported on a plurality of ground engaging devices 208 or motivators 210, here, a plurality of wheels 212. A cab or operator station 238 may be supported on the frame 206. A lift arm 220 is pivotably coupled to the frame 206 at one end, and to an implement 216, here, a bucket 218 at that other end.

The wheel loader 202 includes a body 207 that may contain an engine 240, a transmission 241, a hydraulic system 242 and an energy recovery system 244 including a pump 243 and one or more valves 245. As with the embodiment of FIG. 1, the energy recovery system 244 of the wheel loader 202 of FIG. 2 may include a hybrid powertrain system including an energy storage system 250. The energy storage system 250 may include components that store energy in electrical, chemical, hydraulic, or mechanical form. By way of example only, the energy storage system 250 may include one or more components such as a flywheel, a battery, an ultracapacitor, a fuel cell, an auxiliary power unit, and one or more accumulators. In the illustrated embodiment, for example, the energy storage system 250 may include one or more accumulators, and the valve 245 may control the flow of fluid from the energy recover system 244 to the accumulators. According to the disclosure, at least a portion of the energy storage system 250 is disposed as a counterweight to the lift arm 220 and implement 216. As with the embodiment of FIG. 1, the machine 200 may include additional counterweight 252.

### INDUSTRIAL APPLICABILITY

The present disclosure is applicable to machines 100, 200 including a load 146, 220, 216 that extends from the machine 100, 200. Thus, while the arrangement is illustrated in connection with an excavator 102 and a wheel loader 202, the arrangement disclosed herein has universal applicability in various other types of machines 100, 200 as well. The term “machine” may refer to any machine that requires the use of a counterweight to balance a load 146, 220, 216, such as machines that perform some type of operation associated with an industry such as mining, construction, farming, transportation, or any other industry known in the art. For example, the machine 100, 200 may be an earth-moving machine, such as a tractor, material handler, a skid steer loader, or the like. Moreover, one or more implements may be connected to the machine 100, 200. Such implements may be utilized for a variety of tasks, including, for example, brushing, compacting, grading, lifting, loading, plowing, ripping, and include, for example, augers, blades, breakers/hammers, brushes, buckets, compactors, cutters, forked lifting devices, grader bits and end bits, grapples, moldboards, rippers, scarifiers, shears, snow plows, snow wings, and others.

In some embodiments, the overall weight of the machine 100, 200 may be reduced inasmuch as the additional counterweight required may be minimized or eliminated entirely. Similarly, this reduction of counterweight may result in fuel savings or a reduction of the costs associated with the inclusion, placement, and maintenance of additional counterweight.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A machine comprising
a frame,
at least one implement,
a linkage assembly movably coupled to the implement and to the frame,
an energy recovery system including an energy storage system, the energy storage system including at least one of a hydraulic accumulator, a battery, a flywheel, an ultra-capacitor, a fuel cell, and an auxiliary power unit, and
at least a portion of the energy storage system being disposed as counterweight to the implement.

2. The machine of claim 1 wherein at least a portion of the energy storage system is disposed as a counterweight to the implement and at least a portion of the linkage assembly.

3. The machine of claim 2 wherein the linkage assembly includes a boom and a stick.

4. The machine of claim 2 further including an undercarriage including a pair of rotatably mounted tracks, the frame being swingably supported on the undercarriage, and wherein at least a portion of the energy storage system is disposed other than as centered about a center of gravity of the machine.

5. The machine of claim 1 wherein at least a portion of the energy storage system is disposed other than as coincident with a center of gravity of the machine.

6. The machine of claim 1 further including an undercarriage, and wherein the frame is swingably supported on the undercarriage.

7. The machine of claim 6 wherein the energy recovery system recovers and stores potential energy resulting from movement of the frame swinging relative to the undercarriage.

8. The machine of claim 1 further including a plurality of motivators.

9. The machine of claim 8 further wherein the motivators include a pair of rotatably mounted tracks.

10. The machine of claim 1 wherein the energy recovery system recovers and stores potential energy resulting from movement of the implement.

11. A moveable machine comprising
a frame,
a plurality of motivators, the frame being supported on the motivators,
at least one implement,
a linkage assembly movably coupled to the implement and to the frame, to define movement of the implement relative to the frame,
an energy recovery system adapted to recover and store potential energy, the energy recovery system including an energy storage system, the energy storage system including at least one of a hydraulic accumulator, a battery, a flywheel, an ultra-capacitor, a fuel cell, and an auxiliary power unit, and
at least a portion of the energy storage system being disposed as counterweight to the implement.

12. The machine of claim 11 wherein at least a portion of the energy storage system is disposed as a counterweight to the implement and at least a portion of the linkage assembly.

13. The machine of claim 12 wherein the linkage assembly includes a boom and a stick.

14. The machine of claim 12 further including an undercarriage including a pair of rotatably mounted tracks, the frame being swingably supported on the undercarriage, and wherein a center of gravity of the energy storage system is disposed other than as coincident with a center of gravity of the machine.

15. The machine of claim 11 wherein at least a portion of the energy storage system is disposed other than as centered about a center of gravity of the machine.

16. The machine of claim 11 further including an undercarriage, and wherein the frame is swingably supported on the undercarriage.

17. The machine of claim 16 wherein the energy recovery system recovers and stores potential energy resulting from movement of the frame swinging relative to the undercarriage.

18. The machine of claim 11 wherein the energy recovery system recovers and stores potential energy resulting from movement of the implement.

19. A machine comprising:
a frame having a first end and a second end,
at least one implement,
a linkage assembly movably coupled to the implement and to the frame substantially along the first end of the frame,
an energy recovery system including an energy storage system, the energy storage system having a center or gravity and including at least one of a hydraulic accumulator, a battery, a flywheel, an ultra-capacitor, a fuel cell, and an auxiliary power unit, and
the energy storage system being disposed along the frame to have the center of gravity other than coincident with a center of gravity of the machine, at least a portion of the energy storage system being disposed substantially along the second end of the frame as counterweight to the implement.

20. The machine of claim 19 including a plurality of hydraulic accumulators, and wherein at least one of the hydraulic accumulators is disposed as counterweight.
